(19) United States
(12) Patent Application Publication
(10) Pub. No.: US 2007/0079364 A1
(43) Pub. Date: Apr. 5, 2007

(54) Directory-secured packages for authentication of software installation

(76) Inventors: Timothy Abels, Pflugerville, TX (US); Aurelian Dumitru, Round Rock, TX (US)

Correspondence Address: HAMILTON & TERRILE, LLP, P.O. BOX 203518, AUSTIN, TX, 78720, US

(21) Appl. No.: 11/240,730

(22) Filed: Sep. 30, 2005

(51) Int. Cl. H04L 9/32

(52) U.S. Cl. 726/10

(57) ABSTRACT

A system and method for authenticating the source, integrity, and associated execution controls, of a plurality of software, including but not limited to, installation packages, updates, patches, and other code components, distributed from a plurality of issuers for implementation on a plurality of predetermined recipient information handling systems operating within a network environment. Current file security is improved by automatically filtering software installation packages to ensure that each package component is signed by a trusted and verified issuer, and has not been tampered with, thereby replacing a weak, native trust model based on firewalls, static filters, reactive detection, and cleansing approaches. The method of the invention utilizes directory services, implemented within a network environment, to monitor and verify which software is currently authorized and implemented on one or more information handling systems operating within the network environment, and whether or not software received over a network is authorized to interact with a predetermined information handling system(s) and/or its previously implemented and authorized software.

### BACKGROUND OF THE INVENTION

1. Field of the Invention

The present invention relates in general to the field of information handling systems, and more specifically, to managing access to software programs.

2. Description of the Related Art

As the value and use of information continues to increase, individuals and businesses seek additional ways to process and store information. One option available to users is information handling systems. An information handling system generally processes, compiles, stores, and/or communicates information or data for business, personal, or other purposes, thereby allowing users to take advantage of the value of the information. Because technology and information handling needs and requirements vary between different users or applications, information handling systems may also vary regarding what information is processed, stored or communicated, and how quickly and efficiently the information may be processed, stored, or communicated. The variations in information handling systems allow for information handling systems to be general or configured for a specific user or specific use such as financial transaction processing, airline reservation, enterprise data storage, or global communications. In addition, information handling systems may include a variety of hardware and software components that may be configured to process, store, and communicate information, and may include one or more computer systems, data storage systems, and networking systems.

Historically, trusted vendors and issuers have used physical media (e.g., disk, tape, CD-ROM, etc.) to distribute software installation packages, updates, patches, and other code components for implementation onto information handling systems. However, as information handling systems increase in number and complexity, and software releases and updates become more frequent and intricate, it is becoming common to distribute software, and/or the components it is comprised of, by using a shared storage and networks as a delivery mechanism. The networks used for such software distribution can be private (e.g., secured corporate networks), public (e.g., the Internet), or hybrid (e.g., a private Intranet implemented on the public Internet).

Furthermore, instead of installing a composite installation package of software on an information handling system, it is possible to deliver only the individual software package components that are applicable, licensed and/or associated with either the system's predetermined function or the usage rights granted to its associated users. Similarly, predetermined software updates, service releases, patches, and other code components can be delivered over a network to one or more predetermined information handling systems. However, delivery of software, and/or associated components, can pose security, reliability, availability, scaling, and performance issues that traditional approaches may not adequately address.

Networked computing environments often have safeguards that are implemented to manage or control the set of software programs that are allowed access to information handling systems that comprise the computer network. Furthermore, it is generally desirable to control which software or components are authorized to execute on individual information handling systems. For example, it is commonly considered necessary to prevent malicious and/or non-business-related software programs from entering, and then executing, on information handling systems comprising an organization's computer network. A malicious software program may include virus programs and other intrusive programs, such as worms, network sniffers, and key loggers. Similarly, non-business-related software programs may include photography management tools, music recording tools, and file sharing programs.

In addition to determining whether or not the software program or component is authorized to execute, there are other security issues that may need to be addressed. For example, even if the software is authorized, its authenticity must be proven, including the validity and trustworthiness of the issuing source. Furthermore, if the software is authentic, it is important to determine if its integrity has been compromised, (e.g., has the file been tampered with, become corrupted in transmission, had malicious code inserted, etc.). Likewise, if the use of the software is authorized and its authenticity has been established (along with validating the trustworthiness of its issuer), it is also important to determine if it is licensed for execution on a predetermined information handling system, or use by a specific user.

Traditional network security approaches can allow undetected malicious code and similar attacks to alter many files prior to detection, including corruption of existing system, application and/or back-up files. Currently, user file security is primarily achieved with firewalls and filters that only detect a predetermined set of known insecurities, working in combination with reactive measures to cleanse the known subset of contaminated files and/or file-like objects that may have been affected. Other approaches, such as implementation of encryption security mechanisms may provide evidence of a software program file's integrity, prove its authenticity, and establish the trustworthiness of its issuer, and in some cases, may even provide licensing and usage controls. However, these approaches are generally limited in their implementation and may not support authentication, integrity, and execution controls when a plurality of software applications and/or components are distributed from a plurality of issuers to a plurality of recipient information handling systems operating within a network environment.

### SUMMARY OF THE INVENTION

In accordance with the present invention, a system and method is disclosed for authenticating the source, integrity, and associated execution controls, of a plurality of software modules, including but not limited to, installation packages, updates, patches, and other code components. These software modules can be distributed from a plurality of issuers for implementation on a plurality of predetermined recipient information handling systems operating within a network environment. Furthermore, the present invention utilizes directory services, implemented within a network environment, to monitor and verify which software is currently authorized and implemented on one or more information handling systems operating within the network environment. The present invention also makes it possible to determine whether a software module received over a network is authorized to interact with a predetermined information handling system.

The present invention provides a Package Directory Services (PDS) that uses predetermined Directory Services, such as Active Directory or LDAP, to uniquely tag previously authorized, implemented, and possibly updated, software, comprised of files and/or file-like objects. In the context of the present invention, file-like objects include any stored information, along with filtered updates, including but not limited to registry settings, directories, file groupings, storage, volumes, web services and other storable data. The method and system of the present invention implements a PDS_TAG, which comprises a secure index into the PDS of each software distribution package, including but not limited to, all associated files and components, package rights, and expiration, along with each file or component's attributes, including but not limited to, size, dates, status, duration, copyright, ownership, category, versions, names, tags/comments and digital rights. Each PDS_TAG is encrypted, to obscure its index into its file, and package attributes. In addition, PDS_TAG encryption is salted with extra bits to hide the file's package(s) membership.

In operation, when an information handling system, or its associated and/or authorized user, attempts to implement software received over a network, the present invention accesses predetermined Directory Services to determine if the received software is authorized to be implemented on the information handling system. In one embodiment of a method of the invention, if the response from the predetermined Directory Services indicates that software received over a network is authorized to be implemented, the invention allows the software to be executed for implementation. Conversely, if the response from the predetermined Directory Services is negative, the software received over a network is prevented from being implemented. In this embodiment, the invention may also include a notification function, such as logging implementation attempts to a file for a future audit.

In another embodiment of a method of the invention, the software authentication function can be implemented on an information handling system that monitors software implementation attempts. When a software implementation attempt is initiated, the software authentication function checks predetermined Directory Services to verify the right of the software to be implemented. In this embodiment of the invention, the system and method of the disclosed invention is configured to prevent implementation of software that has not been authenticated for use. The system and method disclosed herein is advantageous because it prevents malicious and/or non-business-related software from being implemented on an information handling system operating in a network environment. Because the disclosed system and method requires all software be authenticated, the system and method can prevent malicious and/or non-business-related code from executing on an information handling system operating in a networked environment, or log specific executions, or prevent specific execution such as file copying. As such, a user could be prevented from running music or photography programs on a business computer, or similarly prevent accessing music or graphic data files.

The system and method disclosed herein can be used to mediate the right of software to execute with the usage rights of one or more predetermined users, whether the software has been previously implemented, or has been received over a network and is pending implementation. In accordance with the system and method disclosed herein, predetermined directory services can include information concerning the authorization and/or usage rights of each user in a network environment. Thus, the system and method disclosed herein can serve in a mediation capacity to manage access to software programs by users in a network environment. Upon recognizing an attempt by a user to access software, the authentication utility disclosed herein can be used to limit access by users to a predetermined set of software programs available in a network environment. Likewise, the technique disclosed herein provides system administrators with the ability to dynamically change the rights of groups of users in order to grant or deny rights to execute certain software applications.

Other technical advantages will be apparent to those of skill in the art, who will also understand that many such embodiments and variations of the invention are possible, including but not limited to those described hereinabove, which are by no means all inclusive.

### BRIEF DESCRIPTION OF THE DRAWINGS

The present invention may be better understood, and its numerous objects, features and advantages made apparent to those skilled in the art by referencing the accompanying drawings. The use of the same reference number throughout the several figures designates a like or similar element.

FIG. 1 is a generalized illustration of an information handling system that can be used to implement the system and method of the present invention.

FIG. 2 illustrates an implementation of a software distribution and implementation system in accordance with one embodiment of the present invention.

FIG. 3 shows a flowchart of steps in an implementation of a method of one embodiment of the invention to create a PDS Package.

FIG. 4 shows a flowchart of steps in an implementation of a method of one embodiment of the invention to create a PDS Package File Filter.

FIG. 5 is a general illustration of a PDS package file filtering system exposed for application control as implemented in accordance with one embodiment of the present invention.

FIG. 6 shows a flowchart of steps in an implementation of a method of one embodiment of the invention, where PDS policy can be set to prevent one or more files to be run or accessed across a network.

### DETAILED DESCRIPTION

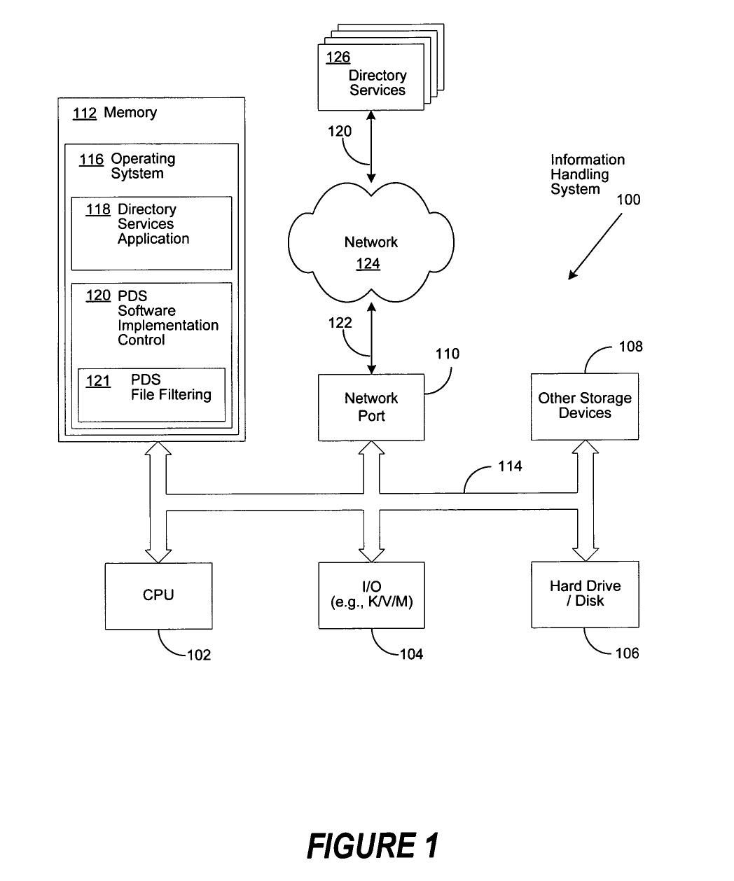

FIG. 1 is a generalized illustration of an information handling system 100 that can be used to implement the system and method of the present invention. The information handling system includes a processor (e.g., central processor unit or “CPU”) 102, input/output (I/O) devices 104, such as a display, a keyboard, a mouse, and associated controllers, a hard disk drive 106 and other storage devices 108, such as a floppy disk and drive and other memory devices, and various other subsystems (e.g., a network port) 110, and system memory 112, all interconnected via one or more buses 114. In an embodiment of the present invention, operating system 116 resides in system memory 112 and supports an implementation of a Directory Services application 118, which is utilized by the present invention for software implementation control 120, comprising file filtering controls 121, by communicating through network port 110, network connection 122, and a private (e.g., secured corporate network), public (e.g., the Internet), or hybrid (e.g., a private Intranet implemented on the public Internet) network 124, to interact with one or more Directory Services 126.

For purposes of this disclosure, an information handling system may include any instrumentality or aggregate of instrumentalities operable to compute, classify, process, transmit, receive, retrieve, originate, store, display, manifest, detect, record, reproduce, handle, or utilize any form of information, intelligence or data for business, scientific, control or other purposes. For example, an information handling system may be a personal computer, a network storage device, or any other suitable device and may vary in size, shape performance, functionality, and price. The information handling system may include random access memory (RAM), one or more processing resources such as a central processing unit (CPU) or hardware or software control logic, read only memory (ROM), and/or other types of nonvolatile memory. Additional components of the information handling system may include one or more disk drives, one or more network ports for communicating with external devices as well as various input and output (I/O) devices, such as a keyboard, a mouse, and a video display. The information handling system may also include one or more buses operable to transmit communications between the various hardware components.

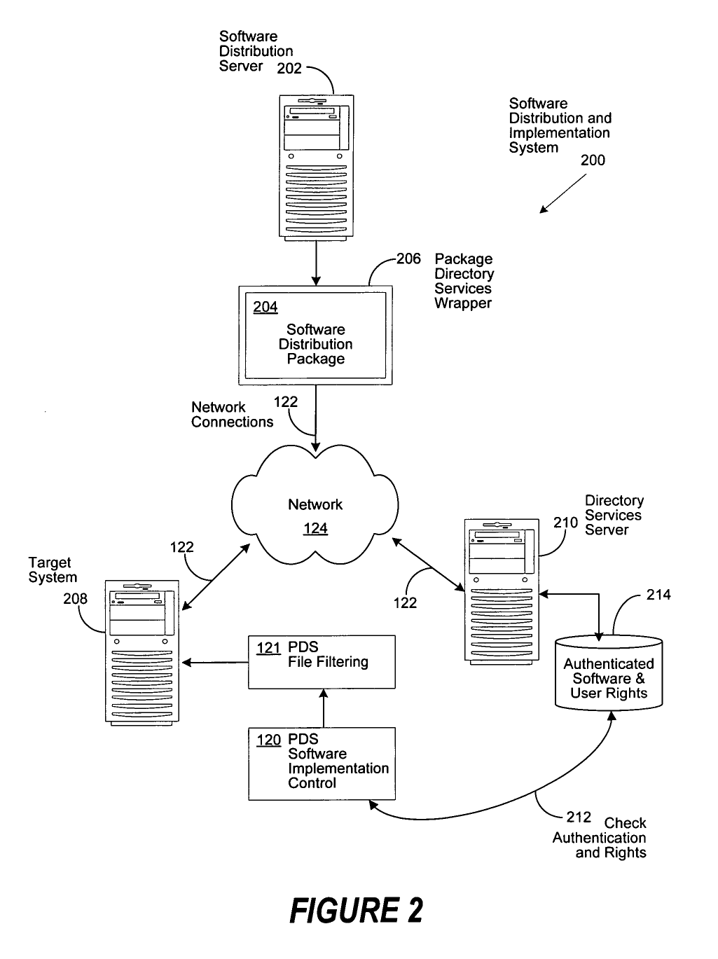

FIG. 2 is a schematic diagram of a software distribution and implementation system 200 in accordance with one embodiment of the present invention. In operation, software distribution server 202 distributes a software distribution package 204, with an attached Package Directory Services tag 206, via a network connection 122 through a private (e.g., secured corporate network), public (e.g., the Internet), or hybrid (e.g., a private Intranet implemented on the public Internet) network 124 to a target information handling system 208. The target information handling system 208 receives the software distribution package 204, with the attached Package Directory Services (PDS) tag 206, via a network connection 122. Upon receipt of software distribution package 204, a Package Directory Services application 120, providing software implementation control, examines the PDS tag 206 for implementation information, which may include network addresses or names of Directory Services servers 210 that may be involved during implementation of the software distribution package 204 and PDS-controlled file filtering 121 per file access event.

Skilled practitioners in the art will be familiar with directory services, which differ from directories, in that it is both the directory information source and the source of the services making the information available and usable to administrators, users, network services, and applications. Ideally, a directory service makes the physical network topology and protocols transparent, so that a user can access any resource without knowing where or how it is physically connected. One such directory service is the Lightweight Directory Access Protocol (LDAP), an open network protocol standard designed to provide access to distributed directories. LDAP provides a mechanism to query or modify information that resides in a directory information tree (DIT), which may contain a broad range of information about different types of objects such as applications, users and other network resources. Another directory service, Active Directory Service (ADS) produced by Microsoft, uses the Domain Name System (DNS), an Internet standard service that translates human-readable computer names to computer-readable numeric IP addresses. ADS hierarchically stores information about network objects and makes it available for searching and querying. Using ADS, a network and its objects are organized by constructs such as domains, trees, forests, trust relationships, organizational units, and sites. Previous to the present invention, information handling system users were unable to utilize Directory Services to filter software applications delivered over a network for malicious and/or non-business-related software programs, and to ensure that each file component of authorized software was signed by a trusted issuer and had not been tampered with.

Referring again to FIG. 2, if network addresses or names of Directory Services servers 210 are present in the PDS tag 206, the Package Directory Services application 120 establishes a network connection 122 with one or more Directory Services servers 210 and accesses information 214 associated with previously authenticated and implemented software, and in some cases, associated user and/or usage rights. Before the software distribution package 204 is implemented on the target information handling system 208, issuer authentication and package integrity is checked 212 by the Package Directory Services application 120, by comparing licensing, usage rights, and other information embedded within PDS tag 206, and associated with software distribution package 204 by accessing information 214 stored in one or more Directory Services servers 210. In an implementation of one embodiment of the invention, files may be filtered by PDS file filtering 121 for additional levels of implementation control as described in more detail hereinbelow.

If the software distribution package 204 meets authentication, integrity, licensing, and usage criteria, then it can be installed on the target information handling system 208. Upon completion, the target information handling system 208 will have a predetermined set of software that has been filtered for malicious and/or non-business-related software, and meets other predetermined criteria.

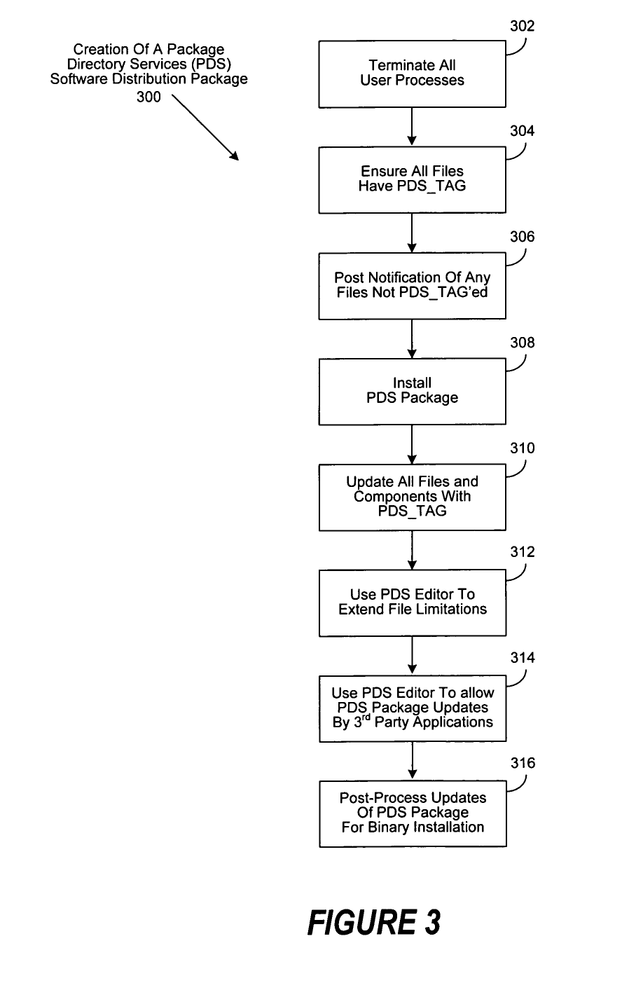

FIG. 3 is a flowchart of an implementation of a method of one embodiment of the invention where a software distribution package, comprised of software and other components, which are indexed, assembled and processed to create a PDS Package. In Step 302, prior to implementation, all running user processes are terminated. In Step 304, all files are checked to ensure they have a PDS_TAG. In Step 306, notification is posted of any files that are not PDS_TAG'ed, and such files are marked for default status or action (e.g., delete, policy, or manual intervention, per file). In Step 308, the package is installed (e.g. CD, ISO image, etc.). In Step 310, post-installation, each file and component is updated with PDS_TAG, and PDS is updated with file and package attributes. In one embodiment of the invention, the PDS_TAG is encrypted and salted, to hide a predetermined Directory Services index, and which files are in which groups and software packages. In Step 312, a PDS editor can be used to extend file limitations, such that it cannot write, execute, be copied, etc. In Step 314, the PDS editor command line can be used to allow third party products to scan the file and recommend file limitations or automatically update the PDS file and package attributes. In Step 316, an additional post-process can update the PDS file and package information for binary installations (e.g., Ghost by Norton), based on post-updates to the package's binary files, such as sysprep tool setting the user, password, and IP address.

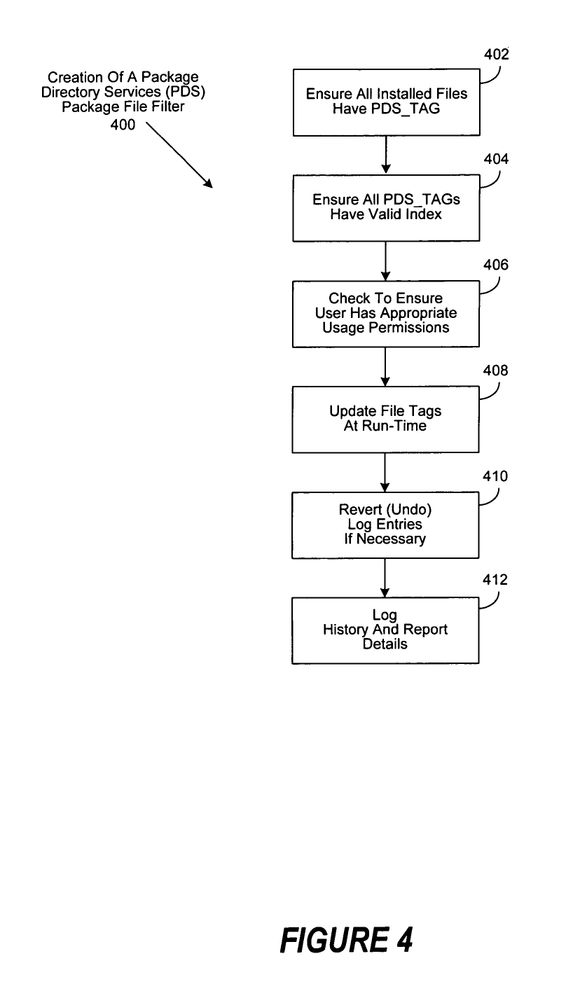

FIG. 4 is a flowchart of an implementation of a method of one embodiment of the invention, where mechanisms that automatically detect access attempts to PDS package files, and also allow users to set defaults, update policy, or one-time overrides, are indexed to create a PDS Package File Filter. In Step 402, the installed file is checked to ensure that a PDS_TAG is present. In Step 404, the file's PDS_TAG is checked to ensure that it has a valid index. In Step 406, if the index is valid, check to ensure (e.g., use Microsoft OS file filterdrv API) that the user has permission for operation (e.g., only allow updates within a package) of that file-like resource. In Step 408, file tags are updated at run-time, including but not limited to, version control, hot updates, or alerts. In Step 410, the operation log can be reverted (e.g., changes undone), if necessary, including but not limited to, changing file-tagged files, groups, and/or install packages. In Step 412, history and report details are logged. Note that files shared across PDS packages have an additional PDS structure that indexes all packages using the file, as well as indexing a counter of current package memberships. The file cannot be deleted until the counter is zero (i.e., only when the last package that uses it is uninstalled).

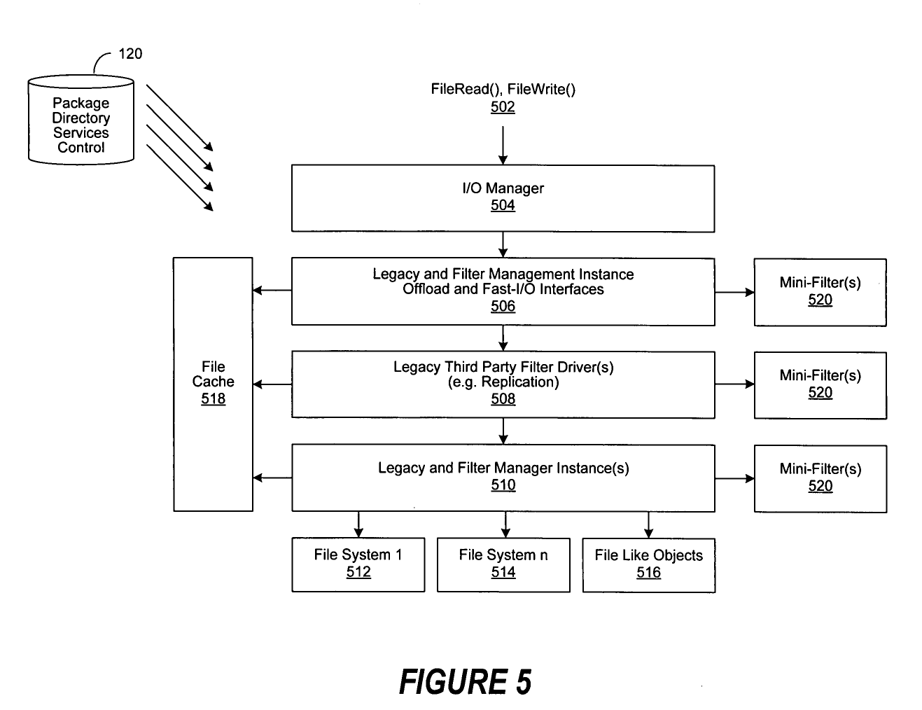

FIG. 5 is a flowchart of a method of one embodiment of the invention where package directory services control 120 implements a file filtering system for additional levels of control during software package implementation on one or more information handling systems, including but not limited to, through shared file systems or by network delivery. In this embodiment of the invention, FileRead( ) and/or FileWrite( ) instructions 502 are received by I/O manager 504. In Step 506, legacy application and filter management instances, along with Fast-I/O interface instructions, can be placed in file cache 518. In Step 508, legacy and third party filter drivers that may already be implemented are filtered and can be placed in file cache 518. In Step 510, legacy and filter manager instances of past implementations can be placed in file cache 518. In an embodiment of the invention, “mini-filters” 520 may be implemented to provide additional levels of filtering control for Steps 506, 508 and 510. Software applications, updates, patches, code components and other operations that remain after filtering operations performed in Steps 506, 508 and 510 can then be implemented on file systems 1-n, 512, 514 and/or file-like objects 516.

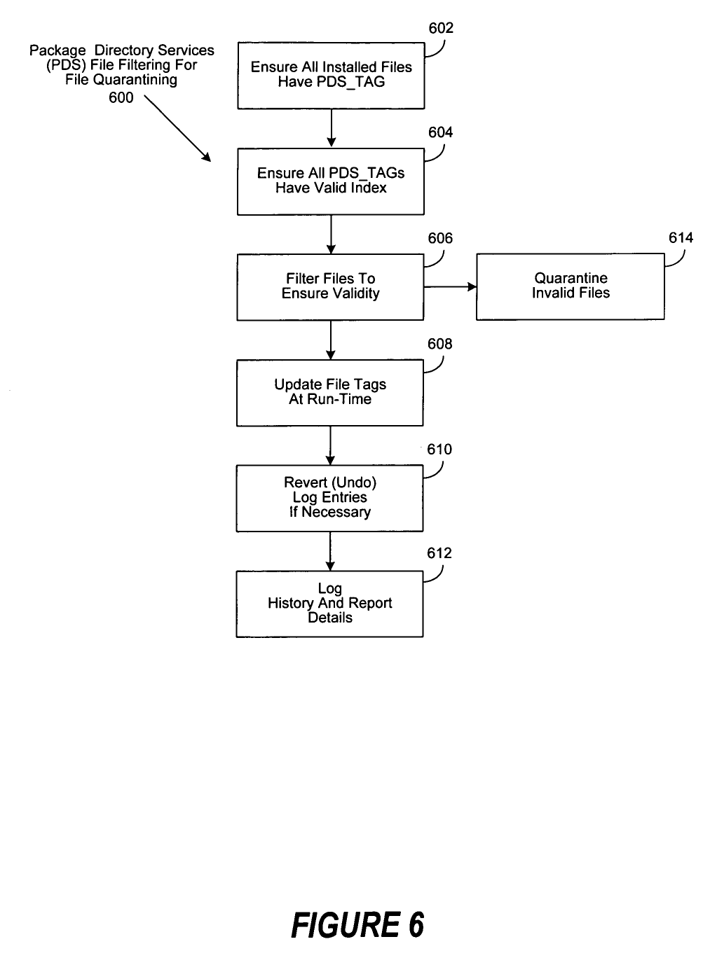

FIG. 6 is a flowchart of an implementation of a method of one embodiment of the invention, where PDS policy can be set to prevent one or more files to be run or accessed across a network. In Step 602, the files are checked to ensure that a PDS_TAG is present. In Step 604, the file's PDS_TAG is checked to ensure that it has a valid index. In Step 606, files are filtered to ensure their validity for implementation. In Step 614, invalid files are quarantined. In one embodiment of the invention, quarantined files are logged and a operator may receive notification. In Step 608, file tags of remaining files are updated at run-time, including but not limited to, version control, hot updates, or alerts. In Step 610, the operation log can be reverted (e.g., changes undone), if necessary, including but not limited to, changing file-tagged files, groups, and/or install packages. In Step 612, history and report details are logged. In an embodiment of the invention, PDS file filtering for file quarantining may be implemented to prevent all but a single file (e.g., mission-critical file, update or patch) to be implemented across a network to one or more information handling systems. For example, an update to a virus protection application may need to be implemented on all information handling systems residing on a network, taking precedence over all other updates or software implementations.

In other embodiments of the invention, the approaches detailed hereinabove can apply to other package creation options, including but not limited to, deployment, cloning, updates or installs. Similarly, the above file tagging approaches described hereinabove can affect many file-like objects, including but not limited to, OS-based storage of registry configurations, dates, services, web services, logs, and events. In an embodiment of the invention, a third party site or portal could provide PDS services for remote, certified Directory-based services, including but not limited to, package creation and file/package verifications, which could include but are not limited to, ensuring license, expiration dates, version control, or hot updates. In other embodiments of the invention, the approaches detailed hereinabove to other Operating System implementations, including but not limited to, Active Directory, Windows file filter API, and .Net run-time.

Skilled practitioners in the art will recognize that many other embodiments and variations of the present invention are possible. In addition, each of the referenced components in this embodiment of the invention may be comprised of a plurality of components, each interacting with the other in a distributed environment. Furthermore, other embodiments of the invention may expand on the referenced embodiment to extend the scale and reach of the system's implementation.

The present invention provides a system and method for improving current file security by automatically filtering software installation packages to ensure that each package component is signed by a trusted and verified issuer, and has not been tampered with, thereby replacing a weak, native trust model based on firewalls, static filters, reactive detection, and cleansing approaches. In addition, current file corruption vulnerability caused by malicious code, non-business-related software, accidents, and system faults, can be mitigated by tagging file-like objects, including but not limited to, registry, directories, file groupings, storage, volumes, and web services, and using the tag as an index to predetermined Directory Services based on but not limited to, file size, date, rights, archive, file security attributes, auditing attributes, reporting attributes, and service attributes.

Furthermore, filtering of file access can be assured, based on the tag index, including but not limited to, filtering files, file groups, and/or specific files, in combination with file access, including but not limited to type-specific, or polled-files. Likewise, file updates that comply with Directory-Based policies can be ensured, per file, install package of files, user, user group, or global users. Additionally, audits and/or reports on all file accesses can be generated by file tag, including but not limited to, grouping by access attempts, both valid and invalid, and by access type, including but not limited to read, write, append, and by file type, whether executable, data, configuration, and also by file attribute update, including but not limited to archive, compressed, hidden, read-only, executable, etc. Correspondingly, file access logs can be reverted to undo file tags, whether by software package, file group, or specific file.

Moreover, overrides can be enacted to allow exceptions to file tagged access by file, file package, or file grouping, and such override exceptions can be complete, or granular by time, file, package, file group, access, user, user group, etc. Similarly, a bulk-dump mode can allow filter-disabling for software implementations, or updates to previously implemented file packages and their PDS updates, thereby enabling multiple machine deployments, and avoiding potential filter or PDS outages.

Although the present invention has been described in detail, it should be understood that various changes, substitutions and alterations can be made hereto without departing from the spirit and scope of the invention as defined by the appended claims.

What is claimed is:

1. A system for authenticating a software package, comprising:
at least one information handling system comprising a memory for storing a plurality of software applications and a processor operable to execute said software applications;
a directory services application stored on said information handling system; and
a package directory services (PDS) application stored on said information handling system, said PDS application being operable to use said directory services application to authenticate a candidate software package for installation on said information handling system.

2. The system of claim 1, wherein said candidate software package comprises a PDS tag.

3. The system of claim 2, wherein said PDS program is operable to examine said PDS tag and to obtain implementation information therefrom.

4. The system of claim 3, wherein said implementation information comprises a network address of a directory services server operable to provide authentication information related to the implementation of said software package.

5. The system of claim 4, wherein authentication provided by said directory services server comprises user rights associated with said software package.

6. The system of claim 5, wherein said PDS program is operable to obtain issuer authentication information associated with said software package.

7. The system of claim 6, wherein said PDS program is further operable to obtain package integrity information associated with said software package.

8. The system of claim 7, wherein said PDS program is further operable to obtain user rights information associated with said software package.

9. The system of claim 8, wherein said issuer authentication, package integrity information, or user rights information is provided by said directory services server.

10. The system of claim 9, wherein said PDS tag is encrypted.

11. A method for authenticating a software package for installation on an information handling system, said information handling system comprising a memory having a plurality of software files stored thereon and a processor operable to execute said software files, the method comprising:
receiving a candidate software package for installation on said information handling system;
using a package directory services (PDS) program to authenticate said candidate software package for installation on said information handling system; and
wherein said PDS program uses a directory services application to access information on a directory services server to obtain information to authenticate said candidate software package.

12. The method of claim 11, wherein said candidate software package comprises a PDS tag.

13. The method of claim 12, wherein said PDS program is operable to examine said PDS tag and to obtain implementation information therefrom.

14. The method of claim 13, wherein said implementation information comprises a network address of a directory services server operable to provide authentication information related to the implementation of said software package.

15. The method of claim 14, wherein authentication provided by said directory services server comprises user rights associated with said software package.

16. The method of claim 15, wherein said PDS program is operable to obtain issuer authentication information associated with said software package.

17. The method of claim 16, wherein said PDS program is further operable to obtain package integrity information associated with said software package.

18. The method of claim 17, wherein said PDS program is further operable to obtain user rights information associated with said software package.

19. The method of claim 18, wherein said issuer authentication, package integrity information, or user rights information is provided by said directory services server.

20. The method of claim 19, wherein said PDS tag is encrypted.
